(19) United States
(12) Patent Application Publication
(10) Pub. No.: US 2014/0352603 A1
(43) Pub. Date: Dec. 4, 2014

(54) Medicine Dosing Indicator

(71) Applicants: Alexandrea Christine Gortot, Valrico, FL (US); LaQuita Michelle Barnhart, St Johns, FL (US)

(72) Inventors: Alexandrea Christine Gortot, Valrico, FL (US); LaQuita Michelle Barnhart, St Johns, FL (US)

(73) Assignee: QUANDAL INC., Saint Johns, FL (US)

(21) Appl. No.: 13/907,958

(22) Filed: Jun. 2, 2013

(51) Int. Cl. A61J 7/04

(52) U.S. Cl. CPC A61J 7/04
USPC 116/308

(57) ABSTRACT

The present invention is a medicine dosing indicator for use in dispensing medication from a container having a neck and a cap. In one embodiment, the indicator comprises a substantially flexible sheet made from heavy weight paper comprising outside and inside surfaces. The sheet further comprises a centrally disposed opening that is larger than the neck of the container and smaller than the cap of the container. The sheet further comprises a slit and first and second end portions disposed adjacent the slit. The outside surface of the sheet comprises a perimeter portion surrounding the central opening. The indicator further comprises a plurality of first indicia indicative of times disposed on the perimeter portion of the sheet. The indicator further comprises a plurality of second indicia indicative of doses disposed on the perimeter portion of the sheet. The first and second end portions are flexed or otherwise moved to mount the central opening of the sheet about the neck of the container.

### BACKGROUND OF THE INVENTION

Children typically take medicine in the form of a liquid. Adults typically take medicine in the form of a pill. Such liquids and pills are dispensed in conventional containers. People sometimes forget when to give a dose of medicine to a child or adults thereby reducing the effectiveness of the medication. There is a need for more compliance with dosing as prescribed and reducing over or under dosing.

### SUMMARY OF THE INVENTION

One object of the present invention is to provide a device or apparatus that can be used with medicine containers to help a person know when to dispense a dose of medicine as prescribed.

The present invention is a medicine dosing indicator that can easily mount to the neck of a medicine container for use in dispensing medication as prescribed or directed. A single indicator is used for each day of the prescribed or directed period and then discarded. In one embodiment, the indicator comprises a substantially flexible sheet made from heavy weight paper comprising outside and inside surfaces. The sheet further comprises a centrally disposed opening that is larger than the neck of the container and smaller than the cap of the container to prevent the sheet from falling off the container. The sheet further comprises a slit and first and second end portions disposed adjacent the slit. The outside surface of the sheet comprises a perimeter portion surrounding the central opening. The indicator further comprises a plurality of first indicia indicative of times disposed along the perimeter portion of the sheet starting from the first end portion. The indicator further comprises a plurality of second indicia indicative of doses disposed along said perimeter portion of said sheet starting from the first end portion. The first and second end portions are flexed or otherwise moved to mount the central opening of the sheet about the neck of the container. A person may circle the times of the day for dispensing of the medication and circle the dosage. As each dosage is dispensed, the circle can be crossed off by the person leaving the next dosage displayed for dispensing.

### BRIEF DESCRIPTION OF THE DRAWINGS

The following description of the present invention will be more fully understood with reference to the accompanying drawings, in which:

FIG. 1 is a perspective view of a medicine dosing indicator according to a first embodiment of the present invention;

FIG. 2 is a top view of the medicine dosing indicator;

FIG. 3 is a front view of the medicine dosing indicator;

FIG. 4 is a perspective view of a medicine dosing indicator according to a second embodiment of the present invention;

FIG. 5 is a bottom view of the medicine dosing indicator of the second embodiment; and

FIG. 6 is a perspective view of a third embodiment of the present invention showing a package having a plurality of medicine dosing indicators stored therein.

### DESCRIPTION OF THE INVENTION

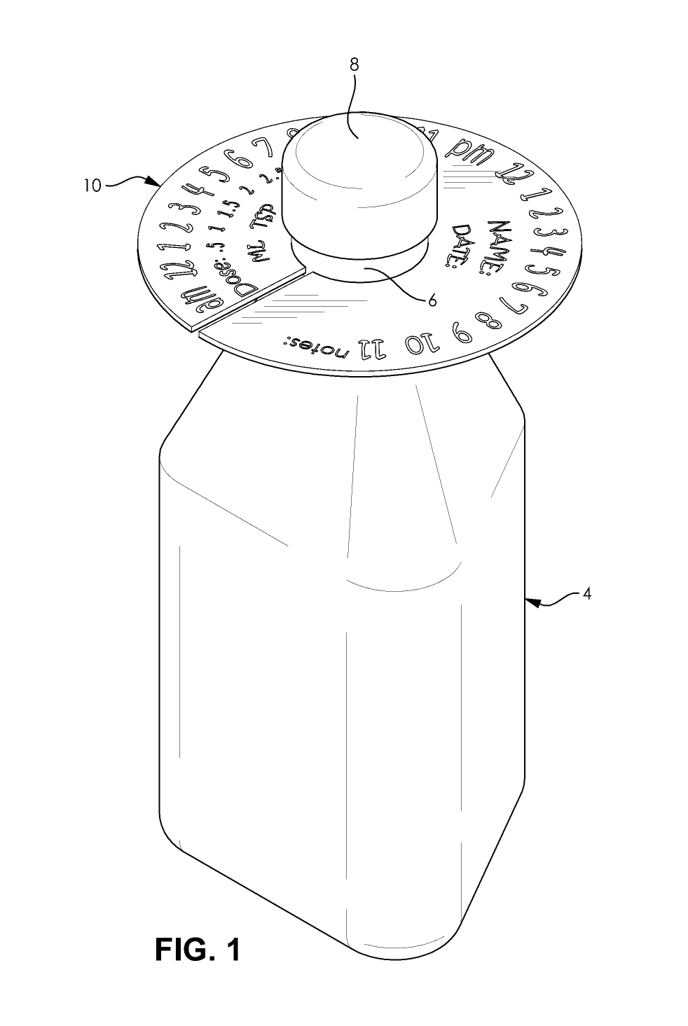

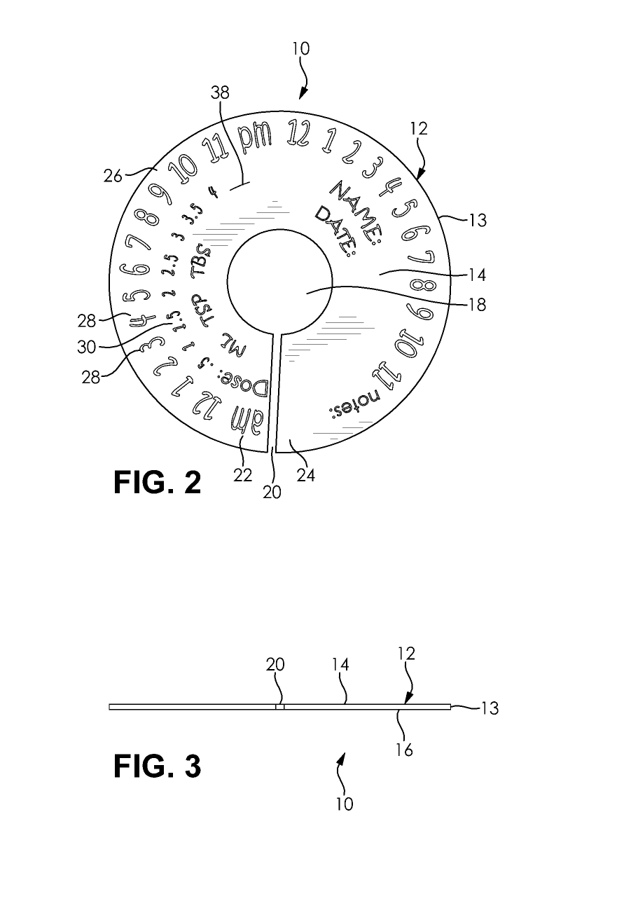

Referring to FIGS. 1-3, a medicine dosing indicator 10 according to the present invention is shown disposed or mounted about a neck 6 of a container 4 having a cap 8. Container 4 is shown with a narrower elongated neck 6 than the body of container 4. Other conventional medicine containers 4 may have a neck 6 that is the same diameter as the body of container 4 or otherwise shaped. As such, for purposes of this specification, neck 6 of container 4 is defined as the portion of container 4 directly below cap 8. Indicator 10 comprises a substantially flexible sheet 12. In the embodiment shown, sheet 12 is substantially circular shaped and has a diameter of about 3.25 inches and a thickness equivalent to 60-80LB heavy weight paper. It is important that sheet 12 does not have a diameter substantially larger than 3.25 inches to avoid covering any directions and/or warnings on container 4. Sheet 12 comprises a perimeter edge 13, an outside surface 14, and an inside surface 16. Sheet 12 further comprises a centrally disposed opening 18 that is larger than neck 6 of container 4 and smaller than cap 8 of container 4 so sheet 12 will not fall off container 4. In the embodiment shown, central opening 18 has a diameter of about one (1) inch. The size of central opening 18 may vary depending upon the size and/or shape of neck 6 of container 4. Although opening 18 has been shown as substantially circular shaped, opening 18 may take other shapes to meet the design requirements of different containers. Sheet 12 further comprises a slit 20 and first and second end portions 22 and 24 disposed adjacent slit 20. First and second end portions 22 and 24 may be flexed to mount central opening 18 of sheet 12 about neck 6 of container 4. Outside surface 14 of sheet 12 has a perimeter portion 26 adapted to receive a variety of indicia (to be described). Sheet 12 is made from 60-80LB heavy weight paper and fabricated by conventional cutting operations.

With continued reference to FIGS. 1-3, indicator 10 further comprises a plurality of first indicia 28 indicative of times disposed on or printed upon perimeter portion 26 of outside surface 14 of sheet 12 starting from first end portion 22. Indicator 10 further comprises a plurality of second indicia 30 indicative of doses disposed or printed upon perimeter portion 26 of outside surface 14 of sheet 12 starting from first end portion 22 and terminating about half-way around perimeter portion 26. Indicia 30 comprises doses displayed as 0.5, 1, 1.5, 2, 2.5, 3, 3.5, and 4. Indicia 30 further comprises a blank line 38 so the person can mark a different dosage if the prescribed or directed dose is not listed. In the embodiment shown, indicator 10 is designed for any person who takes medicine in the form of liquid. As such, the dosage indicated by indicia 30 is measured in ML, TSP, and TBS. In another embodiment, indicator 10 could be designed for adult use such that the dosage indicated by indicia 30 is displayed in pill dosage such as tablets and capsules, or any other pill dosage format. Indicia 28 and 30 are printed on perimeter portion 26 of sheet 12 by conventional printing processes.

In use, first and second end portions 22 and 24 may be flexed to mount central opening 18 of sheet 12 about neck 6 of container 4. A person may circle indicia 28 indicative of the time for dispensing of medication and circle indicia 30 indicative of the dosage. As each dosage is dispensed, the person may cross off indicia 28 leaving the next dispensing time and next dosage displayed to the person.

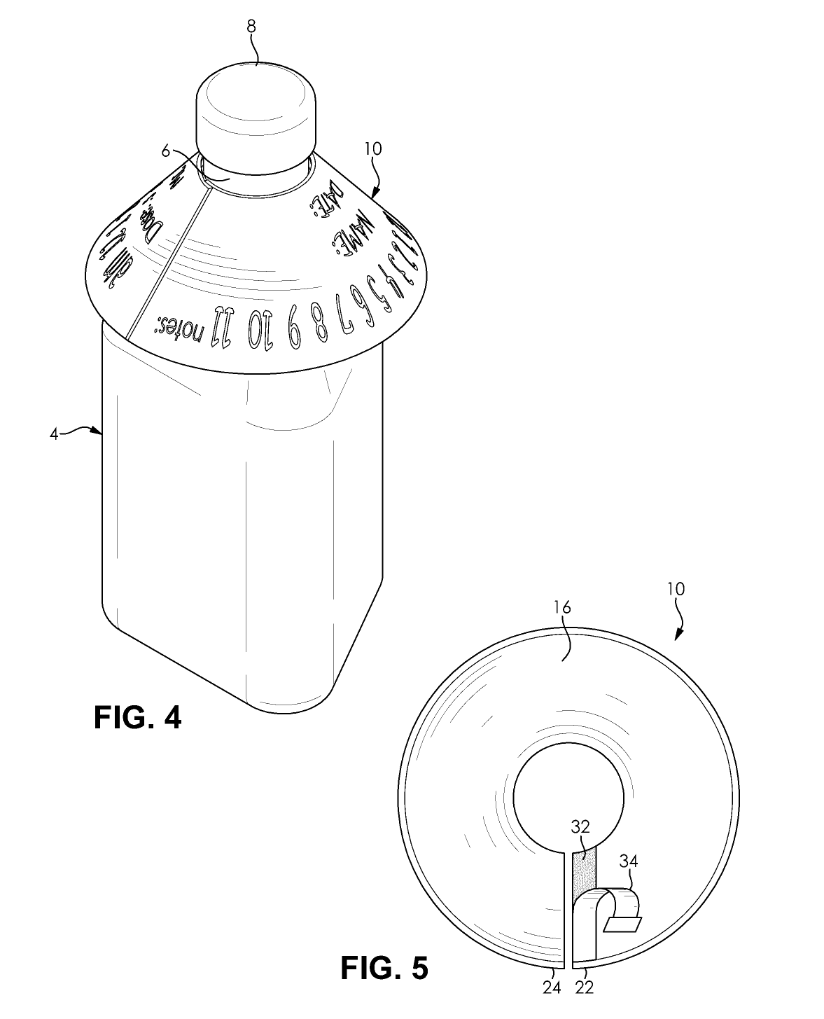

Referring to FIGS. 4 and 5, a second embodiment of indicator 10 is shown having a cone shaped body when fastened or mounted to neck 6 of container 4 as opposed to a flat body of FIG. 1. A conventional adhesive 32 is disposed on inside surface 16 of first end portion 22. A release strip 34 is provided to protect or cover adhesive 32 during non-use and can be easily removed to expose adhesive 32. First and second end portions 22 and 24 are flexed or otherwise moved to mount central opening 18 of sheet 10 about neck 6 of container 4. Thereafter, release strip 34 may be removed and first end portion 22 can be moved into secure contact with second end portion 24 by adhesive 32 thereby securing and/or tightening indicator 10 about or to neck 6 of container 4.

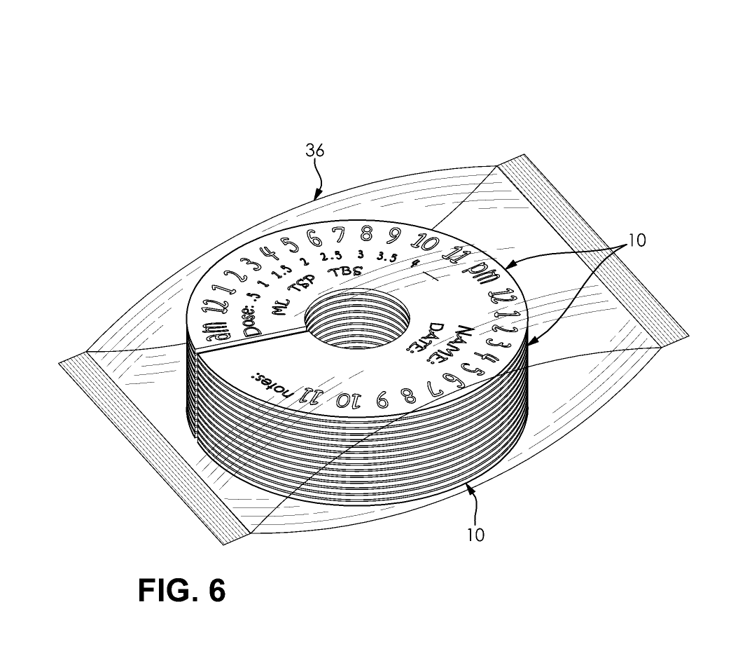

Referring to FIG. 6, where a transparent plastic package 36 is provided to store and/or sell a plurality of indicators 10. A single indicator 10 is used each day and then disposed or otherwise discarded. In the embodiment, shown package 36 has a total of twenty-five (25) indicators 10 enough to supply a prescribed dosage of twenty (21) days.

Indicator 10 has been described as an aid for a person to dispense medication as prescribed to another person. However, indicator 10 may be used as in aid in dispensing any type of medication. By way of example only, such medication may be for pets or other animals who need to take medication in a prescribed or directed manner.

The foregoing description is intended primarily for purposes of illustration. This invention may be embodied in other forms or carried out in other ways without departing from the spirit or scope of the invention as claimed. Modifications and variations still falling within the spirit or scope of the claimed invention will be readily apparent to those of skill in the art.

What is claimed:

1. A medicine dosing indicator for use in dispensing medication from a container having a neck and a cap, the indicator comprising:
a substantially flexible sheet comprising outside and inside surfaces; said sheet further comprises a centrally disposed opening that is larger than the neck of the container and smaller than the cap of the container; said sheet further comprises a slit and first and second end portions disposed adjacent said slit; said outside surface of said sheet comprises a perimeter portion surrounding said central opening;
a plurality of first indicia indicative of times disposed on said perimeter portion of said sheet starting from said first end portion;
a plurality of second indicia indicative of doses disposed on said perimeter portion of said sheet starting from said first end portion; and
whereby said first and second end portions may be flexed to mount said central opening of said sheet about the neck of the container.

2. The medicine dosing indicator of claim 1, further comprising an adhesive disposed on said inside surface of said first end portion so said first end portion can be secured to said second end portion about the neck of the container.

3. The medicine dosing indicator of claim 2, further comprising a release strip covering said adhesive.

4. The medicine dosing indicator of claim 3, wherein said centrally disposed opening is substantially circular shaped.

5. The medicine dosing indicator of claim 4, wherein said sheet is substantially circular shaped when said first end portion is not secured to said second end portion.

6. The medicine dosing indicator of claim 5, wherein said sheet is made from paper.

7. The medicine dosing indicator of claim 6, wherein said first and second indicia are printed on said perimeter portion of said sheet.
